(19) United States
(12) Patent Application Publication
(10) Pub. No.: US 2024/0371565 A1
(43) Pub. Date: Nov. 7, 2024

(54) Wireless Charging Receiver

(71) Applicant: Google LLC, Mountain View, CA (US)

(72) Inventors: Li Wang, Palo Alto, CA (US); Liyu Yang, San Jose, CA (US); Stefano Saggini, Udine (IT); Liang Jia, Palo Alto, CA (US); Yanchao Li, San Jose, CA (US); Zhenxue Xu, Cupertino, CA (US); Haoquan Zhang, Mountain View, CA (US); Mauricio Antonio Alvarado Ortega, Palo Alto, CA (US); Giulia Segatti, Udine (IT); Pingsheng Wu, Taipei (TW); Srikanth Lakshmikanthan, Milpitas, CA (US); Qi Tian, San Jose, CA (US); Veera Venkata Siva Nagesh Polu, Cupertino, CA (US); Yung-Chih Chen, New Taipei City (TW); Yi Lin Chen, New Taipei (TW); Wei Chen Tu, Taipei (TW)

(73) Assignee: Google LLC, Mountain View, CA (US)

(21) Appl. No.: 18/742,738

(22) Filed: Jun. 13, 2024

Related U.S. Application Data
(60) Provisional application No. 63/651,575, filed on May 24, 2024.

(51) Int. Cl. H01F 27/28; H01F 27/29; H02J 50/10

(52) U.S. Cl. CPC H01F 27/2823; H01F 27/29; H02J 50/10

(57) ABSTRACT

A wireless charging receiver that includes a first coil, a second coil, and a nanocrystalline sheet is disclosed. The first coil is configured to be located within a recess in the nanocrystalline sheet and is positioned between the second coil and the nanocrystalline sheet. The first coil includes first and second terminals and the second coil includes third and fourth terminals. The first terminal is connected to the third terminal and the second terminal is connected to the fourth terminal to electrically connect the first coil to the second coil. The first coil may be formed of a flexible printed circuit board having a continuous trace or may be formed of litz wire. The first coil may be a hybrid coil with a first portion formed of a flexible printed circuit board having a continuous trace and with a second portion formed of litz wire.

### CROSS-REFERENCE TO RELATED APPLICATION(S)

This application claims the benefit of U.S. Provisional Patent Application Ser. No. 63/651,575 filed on May 24, 2024, the disclosure of which is incorporated by reference herein in its entirety.

### SUMMARY

This document describes components of a wireless charging receiver. The wireless charging receiver may be a magnetic power profile receiver as designated in the Qi v2.0 specification established by the Wireless Power Consortium (WPC). In one aspect, the wireless charging receiver comprises a first charging coil (first coil), a second charging coil (second coil), and a nanocrystalline sheet (e.g., a magnetic shield). The wireless charging receiver may include additional components as discussed herein. The first coil is positioned between the second coil and the nanocrystalline sheet. The first coil is configured to be positioned within a recess formed in the nanocrystalline sheet. The first coil is aligned with the second coil, and the two coils are electrically connected together. The recess in the nanocrystalline sheet enables the addition of the first coil without increasing the overall height of the wireless charging receiver.

The first coil may be comprised of various materials formed in a plane. The plane may be an x-y plane. In one implementation, the first coil is formed of a flexible printed circuit board in a planar configuration with a copper trace providing a conductive portion of the first coil. In another implementation, litz wire is formed in a planar configuration. In yet another implementation, a first portion of the first coil is formed of a flexible printed circuit board having a continuous copper trace and a second portion of the first coil is formed of litz wire that is electrically connected to the copper trace of the flexible printed circuit board. The conductive portion of the first coil is connected to a first terminal and a second terminal. The second coil includes a third terminal and a fourth terminal. The first and second coils are electrically connected via the engagement of the third terminal with the first terminal and the fourth terminal with the second terminal.

In some aspects, the nanocrystalline sheet includes a circular rim and a circular central protrusion with the recess being formed between the circular rim and the circular central protrusion. The circular rim may be configured to position an outer edge of the first coil inward from the outer edge of the assembly. The second coil is formed of conductive wire. The conductive wire may have a circular cross-section, and the first coil may have a non-circular cross-section.

In example implementations, an apparatus includes a nanocrystalline sheet having an annular recess. The apparatus includes a first coil wound in a plurality of concentric loops defining a plane, the first coil having a conductive portion and being positioned within the annular recess. The apparatus includes a first terminal connected to the conductive portion of the first coil and a second terminal connected to the conductive portion of the first coil. The apparatus includes a second coil including conductive wire, the second coil being aligned coaxially with the first coil, the first coil being positioned between the nanocrystalline sheet and the second coil. The apparatus includes a third terminal connected to the conductive wire, the third terminal configured to connect to the first terminal. The apparatus includes a fourth terminal connected to the conductive wire, the fourth terminal configured to connect to the second terminal.

This summary is provided to introduce simplified concepts concerning a wireless charging receiver, which is further described below in the Detailed Description. This summary is not intended to identify essential features of the claimed subject matter, nor is it intended for use in determining the scope of the claimed subject matter.

### BRIEF DESCRIPTION OF DRAWINGS

Apparatuses of and techniques for a wireless charging receiver are described with reference to the following drawings. The same numbers are used throughout the drawings to reference like features and components:

FIG. 1 illustrates an exploded view of an example apparatus for a wireless charging receiver;

FIG. 2 illustrates an exploded view of an example apparatus for a wireless charging receiver;

FIG. 3 illustrates an exploded view of an example apparatus for a wireless charging receiver;

FIG. 4 illustrates a cross-sectional view of an example apparatus for a wireless charging receiver; and

FIG. 5 illustrates a flexible printed circuit board that is a component of an example apparatus for a wireless charging receiver; and

FIG. 6 illustrates an example electronic device having a wireless charging receiver in accordance with one or more implementations.

### DETAILED DESCRIPTION

### Overview

The use of wireless charging for mobile phones is growing rapidly. The market for other consumer electronics, such as wireless electronic devices with small form factors, is also growing. One of the fastest-growing markets is wearable technology, which includes smartwatches, smart glasses, wireless earbuds, and so forth. These mobile devices have a small form factor, which may restrict the size of an inductive coil that can be implemented for wireless charging. A wireless charging receiver may be a magnetic power profile receiver, which may have sizing fixed by various standards, such as the Qi standard established by the WPC. A magnetic power profile receiver may typically include a magnet array, a support plate, a bottom enclosure, a copper shield, conductive metal, a magnetic shield, and a charging coil. Efficiency is highest when a wireless charger has a transmitting inductive coil that substantially matches the size of a receiving inductive coil at the mobile device and the inducting, or charging, coils are aligned.

Existing magnetic power profile receivers as described in the Qi v2.0 standard tend to have very high losses at a power level of 32 Watts. These high losses may be due to a high direct current (DC) resistance of the charging coil of the magnetic power profile wireless charging receiver. The charging coil of a magnetic power profile receiver generally includes windings that are very close to the outer edge of the magnetic power profile receiver, which may lead to a higher alternating current (AC) resistance strand on the last turn of the charging coil. The Qi v2.0 standard includes a magnetic shield, which is typically a nanocrystalline member. The DC losses of the magnetic power profile receiver are mainly due to the charging coil windings and not the magnetic shielding.

DC losses of the charging coil can potentially be overcome by increasing the cross section of the coil windings. However, one challenge of adding additional windings is that the overall height of the charging coil(s) may need to be increased, leading to an overall height of the wireless charging receiver. The overall height may be increased in a z plane. To maintain a sleek and thin form factor for a mobile device, it may be desired to not increase the charging coil height. Further, adding an additional charging coil or increasing the height of the charging coil in a magnetic power profile receiver may not meet the Qi v2.0 standard.

A portion of the magnetic shielding (e.g., a nanocrystalline sheet) may be removed to enable additional windings to be added to the charging coil of the wireless charging receiver in an effort to reduce the DC losses. An annular recess is formed in the nanocrystalline sheet to receive an additional, or first, coil. The recess in the nanocrystalline sheet enables the addition of the first coil without increasing the overall height of the wireless charging receiver. The first coil is configured to be positioned within the recess formed in the nanocrystalline sheet.

In one aspect, the first coil may be comprised of a flexible printed circuit board formed in a plane and configured to be positioned within the recess in the nanocrystalline sheet. A continuous copper trace on the flexible printed circuit board provides additional turns for the charging coil of the wireless charging receiver. In one implementation, the first coil may be comprised of litz wire formed in a plane and configured to be positioned within the recess in the nanocrystalline sheet. The litz wire provides additional turns for the charging coil of the wireless charging receiver. In yet another aspect, the first coil may be a hybrid coil comprised of a first portion formed of a flexible printed circuit board formed in a plane and a second portion of litz wire also formed in a plane, which may be the same place as that of the flexible printed circuit board. A copper trace on the first portion is electrically connected to a conductive portion of the litz wire.

This document details that the first coil is aligned with a second coil formed of conductive wire. The first coil is electrically connected with the second coil. The first coil includes a first terminal and a second terminal electrically connected to conductive portions of the first coil. The second coil includes a third terminal and a fourth terminal electrically connected to the conductive wire of the second coil. The third terminal is configured to connect to the first terminal and the fourth terminal is configured to connect to the second terminal to electrically connect the first coil to the second coil. The additional winding provided by the first coil may reduce the DC losses without adding additional width to the wireless charging receiver.

In one implementation, the nanocrystalline sheet includes a circular rim along an exterior edge of the nanocrystalline sheet. The circular rim is configured to position the last turn of the first coil away from an exterior edge of the wireless charging receiver. A width of the circular rim ensures that the last turn of the first coil is positioned inward from the exterior edge of the wireless charging receiver. These and other implementations are described herein.

### Example Apparatuses and Systems, and Operational Schemes

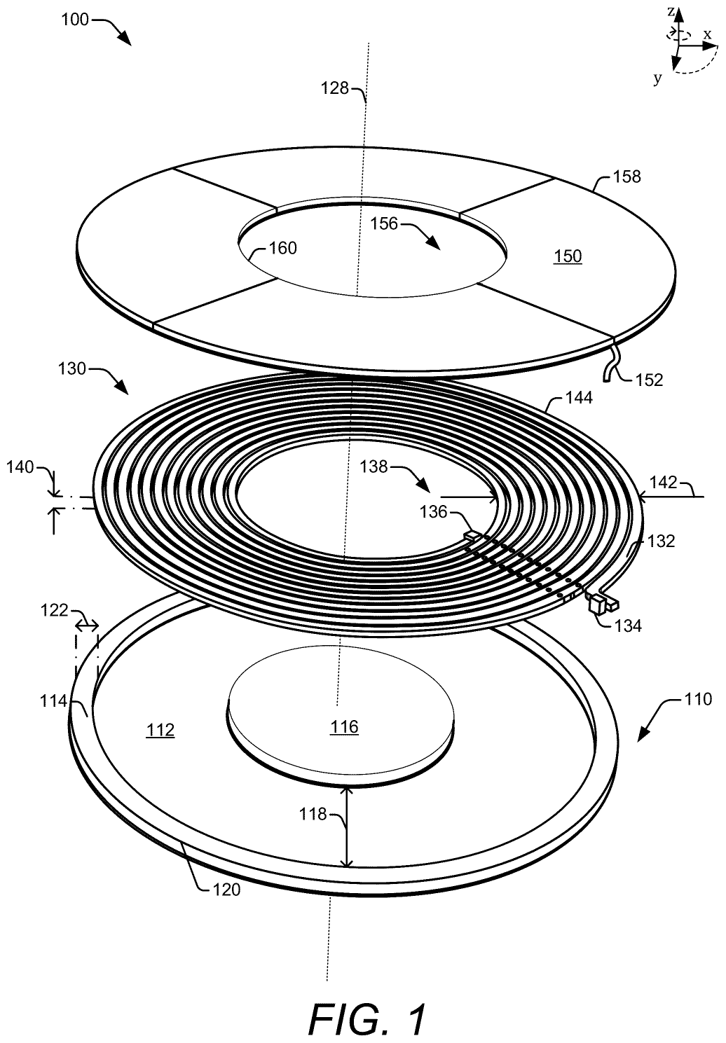

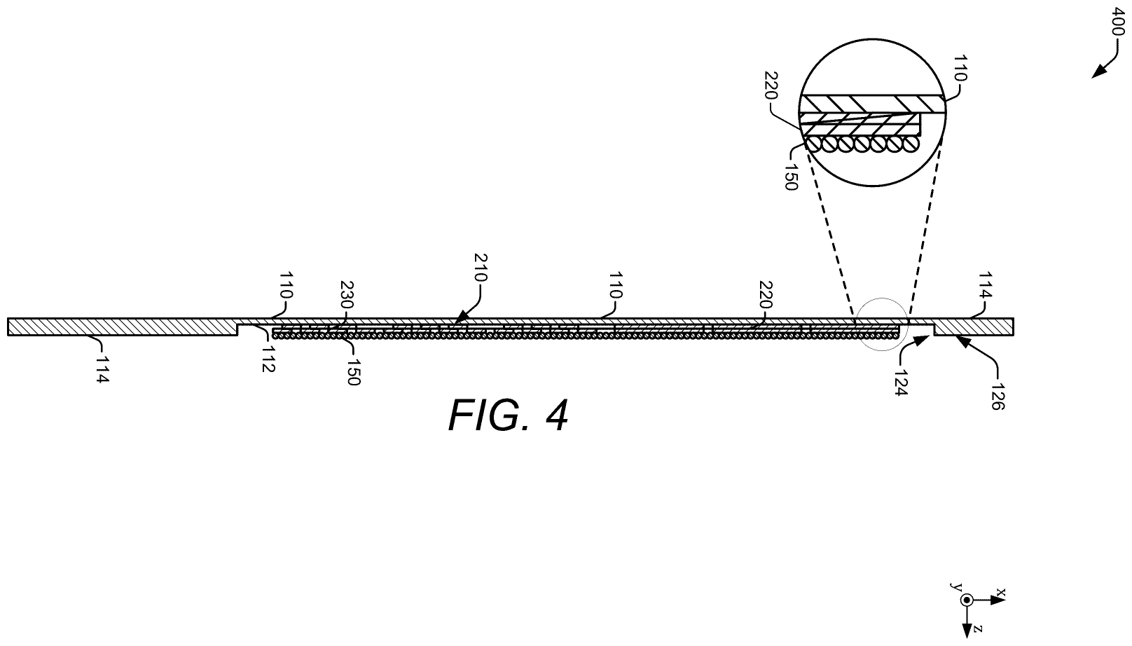

FIG. 1 illustrates an example apparatus 100 for wirelessly charging a device. The apparatus 100 may be components of a wireless charging receiver for wirelessly charging, from a wireless transmitter, a device connected to the apparatus 100. The apparatus 100 includes a nanocrystalline sheet 110. The nanocrystalline sheet 110 includes an annular recess 112 positioned between a circular rim 114 and a circular central protrusion 116. The nanocrystalline sheet 110 includes a central axis 128. The annular recess 112 has a first width 118 measured between the circular rim 114 and the circular central protrusion 116. The circular rim 114 runs along an exterior edge 120 of the nanocrystalline sheet 110 and has a width 122. The circular rim 114 has a first height 124 (best shown in FIG. 4) measured from a base of the annular recess 112 to a top surface 126 (shown in FIG. 4) of the circular rim 114.

The apparatus 100 includes a first coil 130. The first coil 130 is wound in a plurality of concentric loops 132 defining a plane and includes a conductive portion. The first coil 130 is configured to be positioned within the annular recess 112 of the nanocrystalline sheet 110. In one implementation, the concentric loops 132 include the conductive portion of the first coil 130 being a continuous copper trace on the printed flexible circuit board. In another implementation, the concentric loops 132 are formed with litz wire, which includes multistrand conductive wires that are each insulated from each other. The first coil 130 includes a first terminal 134 connected to the conductive portion of the first coil 130 and a second terminal 136 also connected to the conductive portion of the first coil 130. The first coil 130 includes a central opening 138 configured to receive the circular central protrusion 116 of the nanocrystalline sheet 110.

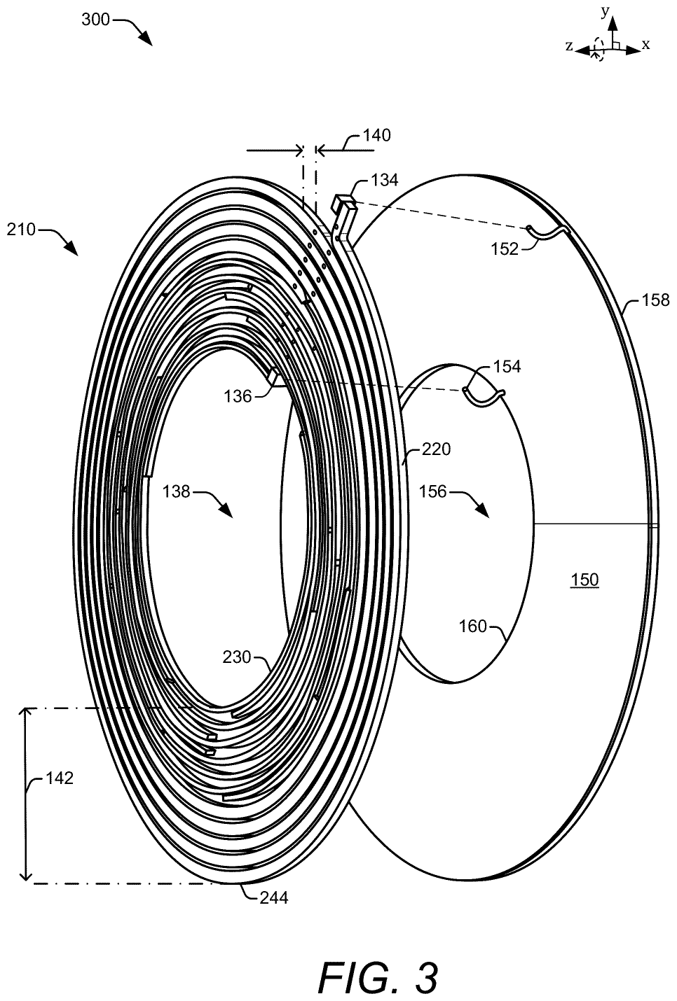

The first coil 130 includes a second height 140 (best shown in FIG. 3) and a second width 142 measured from an outer edge 144 of the first coil 130 to the central opening 138. The second height 140, the second width 142, and the central opening 138 of the first coil 130 are configured to enable the first coil 130 to be positioned within the annular recess 112 of the nanocrystalline sheet 110. The second height 140 of the first coil 130 is equal to or less than the first height 124 (shown in FIG. 4) of the circular rim 114 of the nanocrystalline sheet 110. Likewise, the second width 142 of the first coil 130 is less than or equal to the first width 118 of the annular recess 112 of the nanocrystalline sheet 110. The circular rim 114 of the nanocrystalline sheet 110 is configured to position the outer edge 144 of the first coil 130 inward from the outer edge 120 of the nanocrystalline sheet 110 toward the central axis 128. In other words, the width 122 of the circular rim 114 is configured to position the outer edge 144 of the first coil 130 inward from the outer edge 120 of the nanocrystalline sheet 110 when the first coil 130 is positioned within the annular recess 112 of the nanocrystalline sheet 110. The annular recess 112 of the nanocrystalline sheet 110 enables the addition of additional turns (e.g., the first coil 130 and a second coil 150), which may reduce DC losses without increasing the overall height of a wireless receiver. The circular rim 114 also positions the last turn of the first coil 130 inward from an outer edge of a wireless receiver, which may reduce the AC resistance strand on the last turn of the first coil 130.

The apparatus 100 includes a second coil 150 that is aligned coaxially with the first coil 130. The first coil 130 and the second coil 150 are coaxially aligned with the central axis 128 of the nanocrystalline sheet 110. The second coil 150 is comprised of conductive wire. The first coil 130 is positioned between the nanocrystalline sheet 110 and the second coil 150. The second coil 150 includes an outer edge 158, a central opening 156, and an inner edge 160 adjacent to the central opening 156. The second coil 150 includes a third terminal 152 connected to the conductive wire of the second coil 150. The third terminal 152 is configured to connect to the first terminal 134 that is connected to the conductive portion of the first coil 130. The second coil 150 includes a fourth terminal 154 connected to the conductive wire of the second coil 150. The fourth terminal 154 (best shown in FIG. 3) is configured to connect to the second terminal 136 that is connected to the conductive portion of the first coil 130. The connection of the third terminal 152 to the first terminal 134 and the connection of the fourth terminal 154 to the second terminal 136 electrically connect the first coil 130 to the second coil 150. The conductive wire of the second coil 150 has a circular cross-section (best shown in FIG. 4), and the plurality of concentric loops 132 of the first coil 130 has a non-circular cross-section.

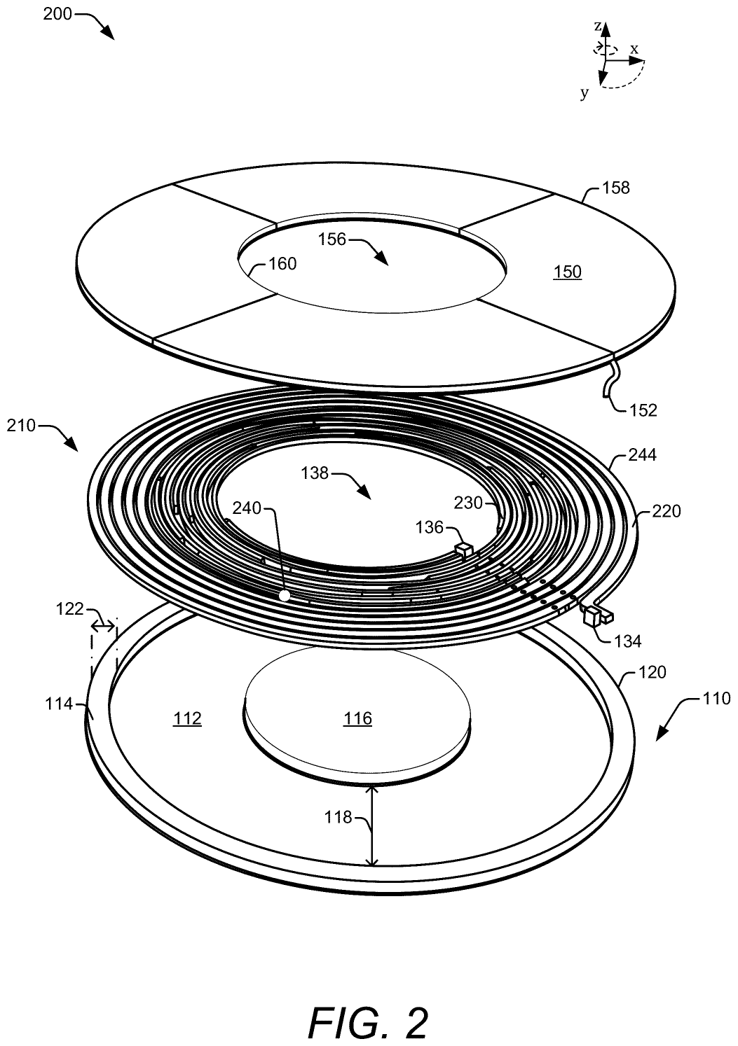

FIG. 2 illustrates an example apparatus 200 that may be part of a wireless charging receiver. The apparatus 200 includes a hybrid first coil 210 for wirelessly charging a device connected to the apparatus 200 from a transmitter coil (not shown). The apparatus 200 includes the nanocrystalline sheet 110 having the annular recess 112 positioned between the circular rim 114 and the circular central protrusion 116. The annular recess 112 has the first width 118 measured from between the circular central protrusion 116 and the circular rim 114. The circular rim 114 extends along the exterior edge 120 of the nanocrystalline sheet 110. The circular rim 114 has the width 122 and the first height 124.

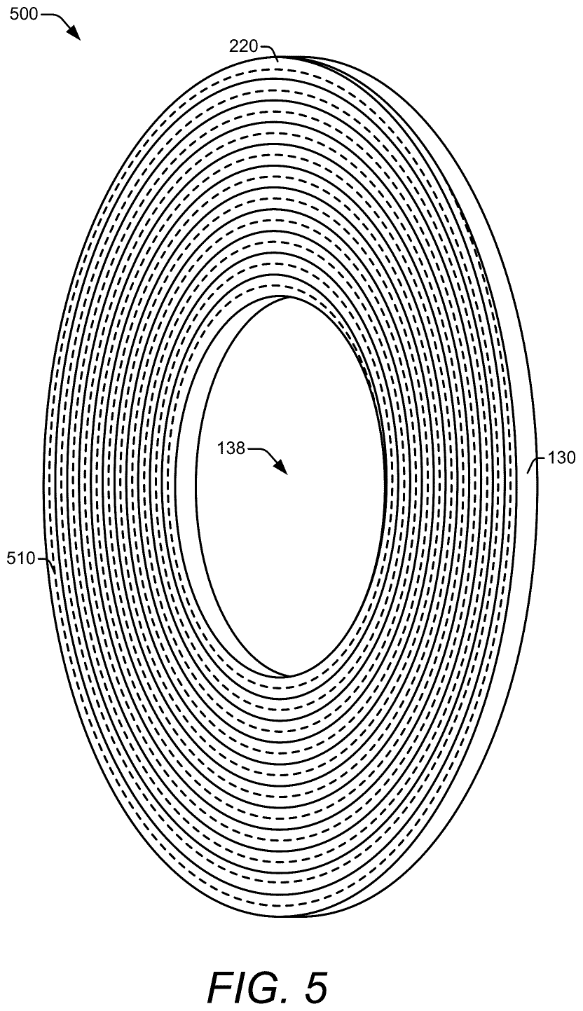

The hybrid first coil 210 is formed of at least two different materials each wound in a plurality of concentric loops 220, 230 defining a plane. Each material of the hybrid first coil 210 includes a conductive portion. The hybrid first coil 210 is comprised of concentric loops 220 of a printed flexible circuit board and concentric loops 230 of litz wire. The concentric loops 220 of the printed flexible circuit board include copper traces (e.g., copper traces 510 shown in FIG. 5) that are conductive and the concentric loops 230 of litz wire include multistrand conductive wires that are each insulated from each other. The hybrid first coil 210 is configured to be positioned within the annular recess 112 of the nanocrystalline sheet 110. The annular recess 112 of the nanocrystalline sheet 110 enables the addition of the hybrid first coil 210 to a second coil 150, which increases the turns of the charging coils 210, 150 of a wireless receiver without increasing the overall height of the wireless receiver. The additional turns of the charging coils 210, 150 may decrease DC losses of the wireless receiver. The circular rim 114 also positions the last turn of the hybrid first coil 210 inward from an outer edge of a wireless receiver toward the central axis 128 of the nanocrystalline sheet 110, which may reduce the AC resistance strand on the last turn of the hybrid first coil 210.

The hybrid first coil 210 includes a first terminal 134 connected to the conductive portion of the concentric loops 220 of the printed flexible circuit board. The hybrid first coil 210 includes a second terminal 136 connected to the conductive wires of the concentric loops 230 of litz wire. The conductive portion of the concentric loops 220 of the printed flexible circuit board is electrically connected to the conductive portion of the concentric loops 230 of the litz wire at a connection point 240. The connection point 240 is shown in FIG. 2 for illustrative purposes, and the location of the connection point 240 between the conductive portion of the concentric loops 220 of the printed flexible circuit board and the conductive portion of the concentric loops 230 of the litz wire may be varied. The concentric loops 220 of the flexible circuit board and the concentric loops 230 of the litz wire are formed in a plane as illustrated in FIG. 2. The hybrid first coil 210 includes a central opening 138 configured to receive the circular central protrusion 116 of the nanocrystalline sheet 110.

The height, the width, and the central opening 138 of the hybrid first coil 210 are configured to enable the hybrid first coil 210 to be positioned within the annular recess 112 of the nanocrystalline sheet 110. The circular rim 114 of the nanocrystalline sheet 110 is configured to position an outer edge 244 of the hybrid first coil 210 inward from the outer edge 120 of the nanocrystalline sheet 110. In other words, the width 122 of the circular rim 114 is configured to position the outer edge 244 of the hybrid first coil 210 inward from the outer edge 120 of the nanocrystalline sheet 110 when the hybrid first coil 210 is positioned within the annular recess 112 of the nanocrystalline sheet 110. The positioning of the last turn of the hybrid first coil 210 inward from an outer edge of a wireless receiver may reduce the AC resistance strand on the last turn of the hybrid first coil 210.

The second coil 150 of the apparatus 200 is aligned coaxially with the hybrid first coil 210. The hybrid first coil 210 is positioned between the nanocrystalline sheet 110 and the second coil 150. The second coil 150 is comprised of conductive wire. The second coil 150 includes a third terminal 152 connected to the conductive wire and a fourth terminal 154 (best shown in FIG. 3) connected to the conductive wire. The third terminal 152 is configured to connect to the first terminal 134 that is connected to the conductive portion of the concentric loops 220 of the printed flexible circuit board of the hybrid first coil 210. The fourth terminal 154 is configured to connect to the second terminal 136 that is connected to the conductive portion of the concentric loops 230 of the litz wire of the hybrid first coil 210. The connection of the third terminal 152 to the first terminal 134 and the connection of the fourth terminal 154 to the second terminal 136 electrically connect the second coil 150 to the conductive portions of the concentric loops 220 of the printed flexible circuit board and the concentric loops 230 of litz wire of the hybrid first coil 210. Thus, the hybrid first coil 210 and the second coil 150 are electrically connected together.

FIG. 3 illustrates an example apparatus 300 that may be part of a wireless receiver used to wirelessly charge a device. The apparatus 300 includes the hybrid first coil 210 and the second coil 150 for wirelessly charging, from a transmitter coil, a device connected to the apparatus 300. The hybrid first coil 210 is formed of at least two different materials each wound in a plurality of concentric loops 220, 230 that define a plane. In one implementation, the hybrid first coil 210 is comprised of concentric loops 220 of a printed flexible circuit board and concentric loops 230 of litz wire. The hybrid first coil 210 includes a first terminal 134 connected to the conductive portion of the concentric loops 220 of the printed flexible circuit board and a second terminal 136 also connected to the conductive wires of the concentric loops 230 of litz wire. As discussed herein, the conductive portions of the concentric loops 220, 230 are electrically connected together. The hybrid first coil 210 has the width 142 measured from a central opening 138 to an outer edge 244 of the hybrid first coil 210. The hybrid first coil 210 has the height 140. The width 142 and height 140 are configured so that the hybrid first coil 210 may be positioned within an annular recess 112 of a nanocrystalline sheet 110 as discussed herein.

The second coil 150 is aligned coaxially with the hybrid first coil 210. The second coil 150 is comprised of conductive wire. The second coil 150 includes an outer edge 158, a central opening 156, and an inner edge 160 adjacent to the central opening 156. The second coil 150 includes a third terminal 152 and a fourth terminal 154 connected to the conductive wire of the second coil 150. The third terminal 152 is configured to connect to the first terminal 134 of the hybrid first coil 210 as indicated by a dashed line. Likewise, the fourth terminal 154 is configured to connect to the second terminal 136 of the hybrid first coil 210 as indicated by a dashed line. The connection of the third terminal 152 to the first terminal 134 and the connection of the fourth terminal 154 to the second terminal 136 electrically connect the hybrid first coil 210 to the second coil 150. In one implementation the outer edge 158 and the inner edge 160 coincide with outer edge 244 and the inner edge of the hybrid first coil 210. In another implementation, the outer edge 158 and the inner edge 160 of the second coil 150 does not coincide with outer edge 244 and the inner edge of the hybrid first coil 210 and a copper trace in the radial direction is configured to connect the third terminal 152 to the first terminal 134 and the fourth terminal 154 to the second terminal 152. In another implementation, a few windings are created near the connection of the first terminal 134 with the third terminal followed by a copper trace in the radial direction with additional windings near the connection between the second terminal 136 and the fourth terminal 154.

FIG. 4 illustrates a cross-sectional view of an example apparatus 400 for wirelessly charging a device. The apparatus 400 includes the hybrid first coil 210 positioned within the annular recess 112 of the nanocrystalline sheet 110. The hybrid first coil 210 is comprised of concentric loops 220 of a printed flexible circuit board and concentric loops 230 of litz wire. The apparatus 400 includes the second coil 150. The hybrid first coil 210 is positioned between the nanocrystalline sheet 110 and the second coil 150. The nanocrystalline sheet 110 includes the circular rim 114 that has the first height 124 measured from the base of the annular recess 112 of the nanocrystalline sheet 110. The hybrid first coil 210 is positioned within the annular recess 112 of the nanocrystalline sheet 110. The conductive wire of the second coil 150 has a circular cross-section and the plurality of concentric loops 220, 230 of the hybrid first coil 210 have a non-circular cross-section as shown in FIG. 4. FIG. 4 shows that the outer perimeter of the second coil 150 is approximately equal to the outer perimeter of the hybrid first coil 210. In some implementations, the outer perimeter of the second coil 150 may extend to the outer perimeter of the nanocrystalline sheet 110. The circular rim 114 of the nanocrystalline sheet 110 is configured to positioned the outer perimeter (e.g., the outer edge 144 shown in FIG. 1) of the first coil 130 inward from the outer perimeter (e.g., the outer or exterior edge 120) of the nanocrystalline sheet 110 towards the central axis 128 of the nanocrystalline sheet 110.

FIG. 5 illustrates an apparatus 500 that may be used to wirelessly charge a device. The apparatus 500 includes the first coil 130 that is formed of the plurality of concentric loops 220 of the printed flexible circuit board that define a plane. The first coil 130 includes the central opening 138 to enable the first coil 130 to be positioned within the annular recess 112 of a nanocrystalline sheet 110 as discussed herein. The concentric loops 220 of the printed flexible circuit board include a conductive copper trace 510 on a first surface (e.g., the top surface). In one aspect, the copper trace 510 may be formed in concentric loops on a surface of a planar circular printed circuit board configured to be positioned within the annular recess 112 of the nanocrystalline sheet 110. The copper trace 510 is shown on the top surface of the concentric loops 220 of the printed flexible circuit board for illustrative purposes and may be positioned on any surface of the printed flexible circuit board to provide a conductive portion for the first coil 130. The copper trace 510 provides a continuous conductive material that extends along the entire length of the concentric loops 220 of the printed flexible circuit board. The copper trace 510 is a continuous unbroken conductive trace and is shown in dashes for illustrative purposes.

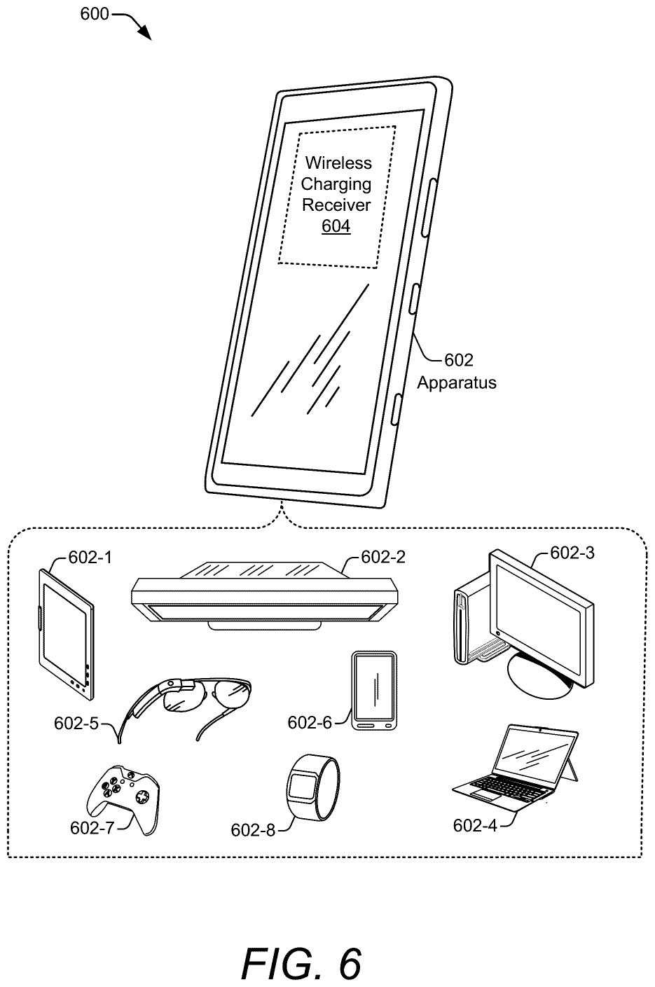

FIG. 6 illustrates a system 600 that includes an example electronic device 602 that includes a wireless charging receiver 604 in accordance with one or more implementations. For example, the wireless charging receiver 604 may include apparatuses 100, 200, 300, 400 disclosed herein. The electronic device 602 may include additional components and interfaces omitted from FIG. 6 for the sake of clarity. The electronic device 602 is illustrated with various non-limiting example electronic devices 602, including a tablet device 602-1, a smart television 602-2, a desktop computer 602-3, a laptop 602-4, computing glasses 602-5, a smartphone (or document reader) 602-6, a gaming system controller 602-7, and a computing watch 602-8. Other devices may also be used, such as a security camera, a trackpad, a drawing pad, a netbook, an e-reader, a wall display, a gaming system console, and a virtual-reality headset, to name just a few examples. Note that the electronic device 602 may be wearable, non-wearable but mobile, or relatively immobile (e.g., desktops and appliances), all without departing from the scope of the present teachings. The wireless charging receiver 604 may be used to charge the electronic device 602 from a wireless charging transmitter.

### Example Aspects and Implementations of a Wireless Charging Receiver

In the following, some example aspects and implementations are described:

Example aspect 1. An apparatus comprising: a nanocrystalline sheet having an annular recess; a first coil wound in a plurality of concentric loops defining a plane, the first coil having a conductive portion and being positioned within the annular recess; a first terminal connected to the conductive portion of the first coil; a second terminal connected to the conductive portion of the first coil; a second coil comprising conductive wire, the second coil being aligned coaxially with the first coil, the first coil being positioned between the nanocrystalline sheet and the second coil; a third terminal connected to the conductive wire, the third terminal configured to connect to the first terminal; and a fourth terminal connected to the conductive wire, the fourth terminal configured to connect to the second terminal.

Example aspect 2. The apparatus of example aspect 1, wherein the first coil comprises litz wire.

Example aspect 3. The apparatus of example aspect 1, wherein the first coil comprises a flexible printed circuit board and the conductive portion of the first coil comprises a copper trace on the flexible printed circuit board.

Example aspect 4. The apparatus of example aspect 1, wherein: the first coil including a first portion comprises a flexible printed circuit board and the conductive portion comprises a copper trace on the flexible printed circuit board; and the first coil including a second portion comprises litz wire, wherein the litz wire is electrically connected to the copper trace on the flexible printed circuit board.

Example aspect 5. The apparatus of example aspect 4, wherein: the first terminal is connected to the copper trace on the flexible printed circuit board; and the second terminal is connected to the litz wire.

Example aspect 6. The apparatus of any one of example aspects 2 to 5, wherein the nanocrystalline sheet comprises: a circular rim along an exterior edge of the nanocrystalline sheet; and a circular central protrusion, wherein the annular recess is positioned between the circular rim and the circular central protrusion, the circular rim has a first height measured from a base of the annular recess, and the annular recess has a first width measured between the circular rim and the circular central protrusion.

Example aspect 7. The apparatus of any one of example aspects 2 to 6, wherein the first coil includes a central opening, the first coil having a second height and a second width measured from an outer edge of the first coil to the central opening.

Example aspect 8. The apparatus of any one of example aspects 2 to 7, wherein the first height is equal to or greater than the second height and the first width is equal to or greater than the second width.

Example aspect 9. The apparatus of any one of example aspects 2 to 8, wherein the conductive wire of the second coil has a circular cross-section and the plurality of concentric loops of the first coil has a non-circular cross-section.

Example aspect 10. The apparatus of any one of example aspects 2 to 9, wherein the circular rim is configured to position the outer edge of the first coil inward from the exterior edge of the nanocrystalline sheet.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

Although implementations for a wireless charging receiver have been described in language specific to certain features and/or methods, the subject of the appended claims is not necessarily limited to the specific features or methods described. Rather, the specific features and methods are disclosed as example implementations for wireless charging receivers.

What is claimed is:

1. An apparatus comprising:
a nanocrystalline sheet having an annular recess;
a first coil wound in a plurality of concentric loops defining a plane, the first coil having a conductive portion and being positioned within the annular recess;
a first terminal connected to the conductive portion of the first coil;
a second terminal connected to the conductive portion of the first coil;
a second coil comprising conductive wire, the second coil being aligned coaxially with the first coil, the first coil being positioned between the nanocrystalline sheet and the second coil;
a third terminal connected to the conductive wire, the third terminal configured to connect to the first terminal; and
a fourth terminal connected to the conductive wire, the fourth terminal configured to connect to the second terminal.

2. The apparatus of claim 1, wherein the first coil comprises litz wire.

3. The apparatus of claim 1, wherein the first coil comprises a flexible printed circuit board and the conductive portion of the first coil comprises a copper trace on the flexible printed circuit board.

4. The apparatus of claim 1, wherein:
the first coil includes a first portion comprising a flexible printed circuit board and the conductive portion comprises a copper trace on the flexible printed circuit board; and
the first coil includes a second portion comprising litz wire, wherein the litz wire is electrically connected to the copper trace on the flexible printed circuit board.

5. The apparatus of claim 4, wherein:
the first terminal is connected to the copper trace on the flexible printed circuit board; and
the second terminal is connected to the litz wire.

6. The apparatus of claim 1, wherein the nanocrystalline sheet comprises:
a circular rim along an exterior edge of the nanocrystalline sheet; and
a circular central protrusion, wherein the annular recess is positioned between the circular rim and the circular central protrusion, the circular rim has a first height measured from a base of the annular recess, and the annular recess has a first width measured between the circular rim and the circular central protrusion.

7. The apparatus of claim 6, wherein the first coil includes a central opening, the first coil having a second height and a second width, the second width measured from an outer edge of the first coil to the central opening.

8. The apparatus of claim 7, wherein the first height is equal to or greater than the second height and the first width is equal to or greater than the second width.

9. The apparatus of claim 8, wherein the conductive wire of the second coil has a circular cross-section and the plurality of concentric loops of the first coil has a non-circular cross-section.

10. The apparatus of claim 9, wherein the circular rim is configured to position the outer edge of the first coil inward from the exterior edge of the nanocrystalline sheet.
